(19) United States
(12) Patent Application Publication
(10) Pub. No.: US 2014/0249783 A1
(43) Pub. Date: Sep. 4, 2014

(54) Method and Device for Estimating Allowable Threat Proximity

(71) Applicant: United States Government, as represented by the Secretary of the Navy, (US)

(72) Inventors: Nicholas V. Nechitailo, King George, VA (US); Christopher E. Glenn, Fredericksburg, VA (US)

(73) Assignee: United States Government, as represented by the Secretary of the Navy, Arlington, VA (US)

(21) Appl. No.: 13/783,604

(22) Filed: Mar. 4, 2013

(51) Int. Cl. G06F 17/50

(52) U.S. Cl. CPC G06F 17/5009
USPC 703/2

(57) ABSTRACT

A method is provided for assessing potential threat from an approaching craft to a target platform. The method includes analyzing a vulnerability parameter of the platform, such that parameter quantifies a threshold to a destructive event. The method further includes observing a characteristic of the craft based on its size and type, and estimating a carrying capacity explosive mass of the craft based on that characteristic. The method further includes computing a risk boundary based on the mass against the parameter as a function of distance between the craft and the platform, displaying a graph of said boundary as the distance varying with respect to the mass, wherein the boundary represents the threshold, and plotting a graphical position of the craft in relation to the mass and the distance on the graph.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to proximity determination and threat assessment against vessels. In particular, the invention relates to a method to assess potential hazard of an approaching small craft in a confined waterway, such as a channel or harbor.

Terrorist attacks include use of a vehicle or otherwise mobile platform to deliver explosive or incendiary material to an intended target, such as a building or other structure, typically with intended and severe loss of life. Such attacks operate by disguising the delivery platform as innocuous until having approached the target within a distance that enables destruction or extensive damage of that target.

One historical example includes the attack on the USS Cole on October 12, 2000 in which seventeen American sailors were killed and more than three dozen others injured. The explosion tore a 40-by-40 foot hole in the side of the US Navy destroyer. The damage assessment suggested that the USS Cole could be fixed at a cost of $150 million to $170 million. The Oklahoma City bombing on Apr. 19, 1995 is another painful, large-scale example in which a rented Ryder truck with explosive (ammonium nitrate, an agricultural fertilizer, and nitromethane, a highly volatile motor-racing fuel) was used to destroy the Murrah building, killing 168 people.

### SUMMARY

Conventional threat assessment techniques yield disadvantages addressed by various exemplary embodiments of the present invention. In particular, a method is provided for assessing potential threat from an approaching craft to a target platform. The method includes analyzing a vulnerability parameter of the platform, such that parameter quantifies a threshold to a destructive event.

The method further includes observing a characteristic of the craft based on its size and type, and estimating a carrying capacity explosive mass of the craft based on that characteristic. The method further includes computing a risk boundary based on the mass against the parameter as a function of distance between the craft and the platform, displaying a graph of said boundary as the distance varying with respect to the mass, wherein the boundary represents the threshold, and plotting a graphical position of the craft in relation to the mass and the distance on the graph.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of a process for detection and analysis of a potential threat;

FIG. 2 is a first graphical view of an envelope plot for an exemplary target; and

FIG. 3 is a second graphical view of the envelope plot.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Suspicious small boats approaching US ships or entering US ports, as well as cars driving by in close proximity to important buildings, a suspected suicide bomber entering a crowd and many other similar situations can be recalled from the recent history to illustrate the scope and horrifying consequences of the problem addressed by various exemplary embodiments.

In the future, the United States (US) Department of Homeland Security (DHS) and US Department of Defense (DOD) is expected to have to confront increased number of attacks aimed at inflicting maximum damage by relatively inexpensive means to deliver explosives. With this trend in mind, a lack of reliable mathematically-supported and physics-based tools hampers the ability of responsible officials to identify the allowable distance from a suspicious vehicle to a US ship or other structure.

A recent conversation with a commanding officer of a US destroyer revealed the need for such tools with which to select defensive and/or mitigating options. The officer, whose education is in the history and political sciences, said that the only tool available on approach of a suspicious boat to the ship is intuition and common sense. Thus, the officer became apprehensive at small boats and leisure airplanes in close proximity to the ship.

If an officer reluctantly decides to attack the suspicious craft, the consequences of an erroneous evaluation befall that officer, irrespective of the justifications that led to conclusions of its hostility. Thus, commanders in the field would prefer to avail of a reliable tool or a technique that would be approved for his decision making process. The exemplary embodiments described herein provide as such.

In summary, there is a need for self-evident devices to quickly evaluate critical distance between a suspicious vehicle and a warship or building. In this example, the most common for the US Navy scenario can be assumed, e.g., a small surface craft approaching a naval frigate in port. The exemplary procedure in this example is applicable to other similar situations.

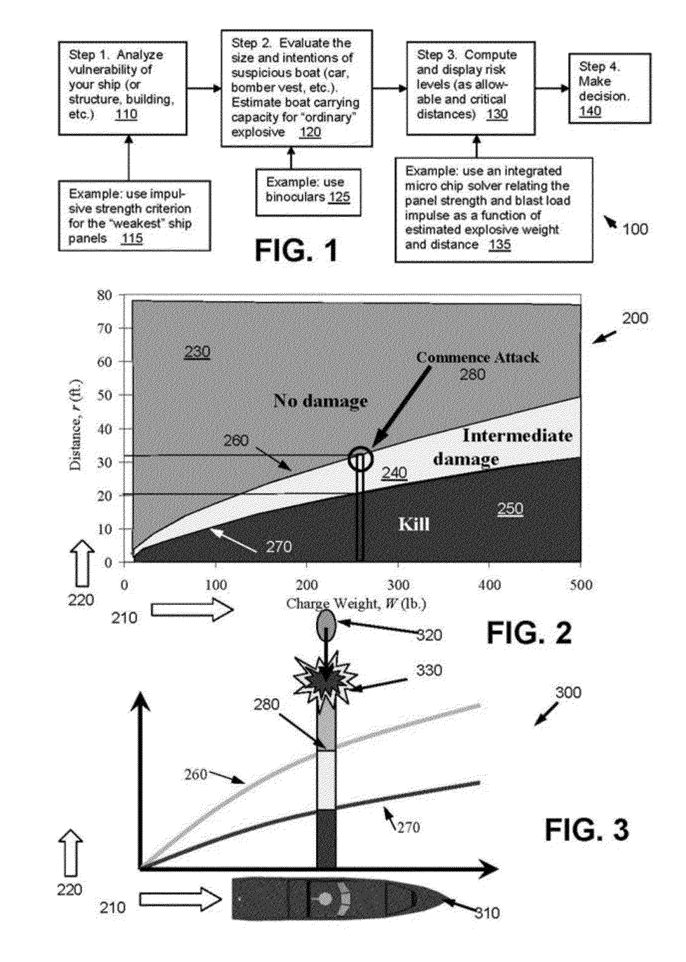

FIG. 1 shows a block diagram view 100 of a process for detection and analysis of a potential threat, such as performed on a computer processor. In the first step at block 110, the vulnerability of a target (e.g., ship or building) is analyzed. An exemplary block 115 provides for determining force necessary to penetrate or rupture the least resistant panel of a ship's hull or structural component in a building.

In the second step at block 120, involves evaluation of size and possible intent of a suspicious craft that is approaching. In particular, the potential carrying capacity of chemical explosive material can be estimated based on the size of the craft in question. An exemplary block 125 provides for instrument augmentation, such as binoculars, to provide detailed information about the craft at a farther distance than by unaided eyesight.

In the third step at block 130, risk levels can be computed and displayed as a plot based on the craft's mass and distance, indicating the craft's disposition on the graph in relation to the risk of threat. An exemplary block 135 provides an application-specific integrated chip (ASIC) that relates hull panel resistance to quantity of explosive that can be transported by the suspicious craft. Finally, in the fourth step at block 140, the official in charge decides on what action to take, such as to warn or shoot at the approaching craft.

The first step 110 can be based on the analysis of the ship panel strength under impulsive loads. Such analysis can be performed in a number of ways, including approximate analytical solutions. As example,

$$C \frac{{I}^{2}}{{h}^{2} ρ {σ}_{o}} > {ɛ}_{max} , \qquad ( 1 )$$

where C is a dimensionless empirical constant that depends on a number of factors including the type of panel material and its aging condition, I is the blast impulse or energy per unit area (pounds[-force]-milliseconds-per-square-inch), h is the thickness (inches) of the ship panel material, ρ is the mass density (pounds[-mass]-per-cubic-inch) of the ship panel material, σ₀ is the material yield (pounds[-force]-per-square-inch or psi) or alternatively ultimate strength, and εₘₐₓ is tensile strain (dimensionless) at failure for the ship panel, (For conversion to the dimensionless strain quantity, the units pounds[-force] are equivalent to pounds[-mass]×3.861×10 inch/msec².)

The impulse I is a function of the type and weight of explosive, and distance to the suspicious boat. As an example, the constant C can be about 0.7 for plates of steel, brass and nickel alloys, or about 1.0 for aluminum alloys. Panel breach occurs when the right side of eqn. (1) exceeds tensile strain for the panel material. For mild steel (e.g., ASTM A36), strain εₘₐₓ at yield corresponds to about 0.3% or 0.003 (inch-per-inch of elongation).

This concept can be further explained by a quantitative example. A naval frigate has a hull plate of quarter-inch in thickness composed of grade-A steel (based on standards by the American Bureau of Shipping), with yield strength σ₀ of at least 34,000 psi, ultimate tensile strength between 58,000 psi and 71,000 psi, and having density ρ of about 0.284 lbm/in³.

Thus, the denominator for the left side of eqn. (1) can be calculated (using inches for the units of length) as (0.25)²×0.284≈34,000=about 600 lbm-lbf/in³ based on yield strength for the higher threshold boundary. The lower threshold boundary uses ultimate tensile strength to produce a denominator value of about 1,000 lbm-lbf/in³.

The second step at block 120 involves evaluation of the suspicious craft, such as by visual observation. Recognizing the craft's capacity and/or seeing the amount of load on the craft, one can estimate the mass quantity of explosives can be aboard. For example, displacement-to-length ratio R_{DL} for a cruising auxiliary yacht ranges between two-hundred and four-hundred. For purposes of this disclosure, R_{DL} represents the displacement D (tons) divided by the cube of 0.01 times water-line length L (feet). The waterline length L can be visually observed.

Assuming that one-quarter of the displacement constitutes explosive stowage, an observed length of twenty feet, i.e., L=20 ft, for a speedboat based on an average R_{DL} of three-hundred indicates a potential hostile payload (in tons) of W=0.25×R_{DL}×(0.01×L)³=0.25×(300×0.008) yielding about 0.6 ton or 1,200 pounds-mass (Ibm).

Distance between the craft and the warship represents another parameter for estimating the impulse I from a potential explosion. For example, impulse can be empirically computed as:

$$I = \frac{{W}^{0.333} \cdot 176.6}{{z}^{1.12}} ( psi m sec ) = {W}^{0.333} \cdot {z}^{- 1.12} \cdot 176.6 ( psi msec ) , \qquad ( 2 )$$

where W is the estimated explosive weight in pounds-mass, and z is the scaled distance (in feet) between the suspected craft and the target warship. The scaled distance relates to physical distance r (in feet) according to:

z=r·W^{-0.333} (3)

Other existing methods and sensors such as radars can augment observation in the second step 120. The boundary at which the craft's distance becomes an inherent threat due to its potential explosive mass can be determined by solving the above equations for the variable physical distance

r=W^{-0.333}z from eqn. (3).

Combining eqns. (2) and (3), the impulse I can be calculated as

$$I = \frac{{W}^{0.706} \cdot 176.6}{{r}^{1.12}} ( psi m sec ) = {W}^{0.706} \cdot {r}^{- 1.12} \cdot 176.6 ( psi msec ) . \qquad ( 4 )$$

For an estimated weight of 1,200 Ibm and a physical distance of 175 feet, the impulse can be calculated as I=176.6×150≧325≈81 psi-msec. At 32 feet, the impulse can be calculated as about 550 psi-msec.

Step three at block 130 involves a rapid analysis of the above input data and solving of the corresponding mathematical equations. This can be accomplished by using a programmable microchip or an ASIC integrated with an optical device. For example, the optical device employed may be the binoculars used to assess the initial distance to the craft and its size estimates.

The 20-ft speedboat can be estimated to have a carrying capacity of 1,200 lbm of explosive. At 32 feet distance, equivalent tensile strain ε of steel can be calculated for constant C of 0.7, impulse I of 550 psi-msec, denominator of 1,000 lbm-lbf/in³, and conversion for gravitational acceleration in inches-per-msec² as from eqn. (1) as 0.7×(550)²×3.861×10⁻⁴+1000=0.08. This level of strain represents a critical threshold at which the hull of a naval vessel, e.g., a frigate or destroyer, could be breached, assuming the approaching boat employs the estimated load of explosives.

At 175 feet, equivalent strain ε from the 20-ft speedboat can be calculated for impulse I of 81 psi-msec and denominator of 600 Ibm-lbf/in³ as 0.7×(81)²×3.861×10⁻⁴≧600=0.003, or onset of yielding. This lower level of strain represents a warning threshold that reaches potential levels of damage. These levels of strain are recognized as limiting factors to hull integrity of the naval asset to be protected. The standoff distances constitute the quantity to be determined based on the physical characteristics of the approaching threat.

Those of ordinary skill will understand that a number of devices can be used to implement the algorithm presented above and visually display the results, FIGS. 2 and 3 depict exemplary embodiments for the display. The upper curve denotes the urgent attention range for decision making and action based on the potential for minor damage. The lower curve identifies the fatal range that results in catastrophic damage to the target warship.

FIG. 2 provides an easy-to-interpret display view 200, with shaded (or colored) “no damage”, “intermediate damage” and “kill” zones. In particular, the abscissa 210 represents charge weight W in pounds-mass (Ibm), and the ordinate 220 represents the scale distance z in feet (ft). The plot shows shaded zones: no damage zone 230, intermediate damage zone 240 and kill zone 250.

The attention interface boundary between the observation and intermediate zones is denoted by an upper curve 260, whereas the decision interface boundary between the intermediate and kill zones is denoted by a lower curve 270. These two different distances can be obtained using either the yield strength or the ultimate strength of the hull material.

For an exemplary threat craft at 1,200 Ibm, the range distance of alarm is 175 ft, and the range distance of threat is 32 ft. At either of these, the commanding officer may decide to warn or attack, such as when the craft reaches a position 280 on the upper boundary 260. The lower boundary corresponds to the condition in which material properties and geometric parameters of external panels of the hull are the strongest (high stress at failure, maximum strain for that material, e.g., potentially thicker panels in the loaded area).

This indicates a sufficiently large charge penetrates the hull at the indicated distance. In contrast, the upper boundary represents the weakest combination of parameters. This means such a given charge may induce permanent damage to the vessel. The zone between the two boundaries represents potential level of damage—from relatively modest to catastrophic.

FIG. 3 shows another easy-to-interpret display view 300, with bargraphed “No damage”, “Intermediate Damage” and “Kill” regions. The warship as target may be displayed as a first icon 310, the craft as an explosive mass may be displayed as a second icon 320, and the threat from destruction may be displayed as a third icon 330, in context to the estimate of the craft's mass in relation to the determined distances that determine the zone the craft is disposed.

Step four at block 140 in the diagram 100 to “Make Decision” may employ a number of “approved” criteria embedded in the algorithm. One criterion is based on the decision to cripple the suspicious craft when it is about to cross from the “no damage” zone to the “intermediate damage” zone shown as in the graph 300. The safe zone 230 serves as an alert or call-to-attention to a commanding officer at the beginning of the decision-making process.

The attention zone 240 represents small-to-serious structural damage to the warship, if the craft indeed is carrying an explosive that would explode within that region. The threat zone 250 can be fatal for the warship. At that distance, an estimated explosive mass aboard the craft can cause significant rupture of the ship's hull and consequent damage to the warship and its personnel.

The proposed algorithm is very general and covers a large area of possible alternative approaches and methods. The proposed optical device with embedded microchip solver is probably the most desirable embodiment of the product for the DoD and DHS. A family of devices can be produced based on this algorithm and its described implementation by those skilled in the art; these possible embodiments are covered by the claims.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented method for modeling assessment of a potential threat from an approaching craft to a target platform having a structural material, said method comprising:
analyzing a vulnerability parameter of the platform, wherein said parameter quantifies a threshold to a destructive event;
observing a characteristic of the craft based on its size and type;
estimating a carrying capacity explosive mass of the craft based on said characteristic;
computing a risk boundary based on said mass against said parameter as a function of distance between the craft and the platform;
displaying a graph of said boundary as said distance varying with respect to said mass, wherein said boundary represents said threshold; and
plotting a graphical position of the craft in relation to said mass and said distance on said graph.

2. The method according to claim 1, wherein said analyzing operation further includes determining a relation
$$C \frac{{I}^{2}}{{h}^{2} ρ {σ}_{o}} > {ɛ}_{max} ,$$
where C is a dimensionless constant, I is blast impulse, h is panel thickness of the target platform, ρ is mass density of the structural material, σ₀ is yield strength of the structural material, and εₘₐₓ tensile strain of the structural material at failure, such that exceeding said strain represents said vulnerability.

3. The method according to claim 2, wherein said estimating operation further includes determining I=W^{0.706}·r⁻¹¹²·176.6 (psi msec), where W is an explosive weight in pounds-mass, and r is a distance in feet.

4. The method according to claim 1, wherein said displaying operation further includes plotting a first boundary that indicates a first threshold of minimal damage, and a second boundary that indicates a second threshold of structural failure.

5. A computer-implemented analysis module for assessing potential threat from an approaching craft to a target platform having a structural material, said device comprising:
an analyzer for evaluating a vulnerability parameter of the platform, wherein said parameter quantifies a threshold to a destructive event;
a receiver for assessing a characteristic of the craft based on its size and type;
an estimator for determining a carrying capacity explosive mass of the craft based on said characteristic;
a processor for computing a risk boundary based on said mass against said parameter as a function of distance between the craft and the platform;
a visual monitor for displaying a graph of said boundary as said distance varying with respect to said mass, wherein said boundary represents said threshold, and for plotting a graphical position of the craft in relation to said mass and said distance on said graph.

6. The module according to claim 5, wherein said analyzer further determines a relation
$$C \frac{{I}^{2}}{{h}^{2} ρ {σ}_{o}} > {ɛ}_{max} ,$$
where C is a dimensionless constant, I is blast impulse, h is panel thickness of the target platform, ρ is mass density of the structural material, σ₀ is yield strength of the structural material, and εₘₐₓ tensile strain of the structural material at failure, such that exceeding said strain represents said vulnerability.

7. The module according to claim 6, wherein said estimator further determines I=W^{0.706}·r^{-1.12}·176.6(psi msec), where W is an explosive weight in pounds-mass, and r is a distance in feet.
